(19) United States
(12) Patent Application Publication
(10) Pub. No.: US 2014/0338450 A1
(43) Pub. Date: Nov. 20, 2014

(54) Acceleration sensor

(71) Applicant: Johannes Classen, Reutlingen (DE)

(72) Inventor: Johannes Classen, Reutlingen (DE)

(73) Assignee: Robert Bosch GmbH, Stuttgart (DE)

(21) Appl. No.: 14/120,383

(22) Filed: May 14, 2014

(30) Foreign Application Priority Data
May 14, 2013 (DE) 10 2013 208 824.8

(51) Int. Cl. G01P 15/125

(52) U.S. Cl. CPC G01P 15/125
USPC 73/514.32

(57) ABSTRACT

An acceleration sensor having a substrate and a seismic mass; the acceleration sensor has a main extension plane and includes a spring device, via which the substrate and the seismic mass are connected, such that in an acceleration in a detection direction that runs perpendicular to the main extension plane, the seismic mass is deflectable in the sense of a tilting motion about an axis of rotation running parallel to the main extension plane, the seismic mass furthermore being connected to the substrate via at least one first spring, the stiffness of the first spring in a deflection of the seismic mass in the sense of the tilting motion being lower in the detection direction than the stiffness of the first spring in a deflection in a primary direction extending parallel to the main extension plane.

### RELATED APPLICATION INFORMATION

The present application claims priority to and the benefit of German patent application no. 10 2013 208 825.6, which was filed in Germany on May 14, 2013, the disclosure of which is incorporated herein by reference.

### FIELD OF THE INVENTION

The present invention relates to an acceleration sensor.

### BACKGROUND INFORMATION

Acceleration sensors of this kind are believed to be generally understood, for instance from the printed publications EP 0 244 581 and EP 0 773 443 B1. In these cases, the seismic mass is connected to the substrate, which may be by a torsion spring, in such a way that in an acceleration that runs perpendicular to the main extension plane, the seismic mass is tilted about an axis of rotation. Together with counter electrodes fixed in place on the substrate, the seismic mass usually forms a plate-type capacitor, whose capacitance changes during the tilting motion of the seismic mass and can therefore be utilized for determining the acceleration in quantitative terms.

High demands are placed on acceleration sensors in the field, especially with regard to their resistance to overloads, which means that they should supply plausible signals even under high mechanical overloading. One error source known in this context results from mechanical clipping of the movable seismic mass. Such clipping may occur in all three spatial directions, but especially in directions that run parallel to the main extension plane (in-plane clipping). Translation motions of the seismic mass in a direction that runs perpendicular to the axis of rotation (the tilting motion), and rotary motions of the seismic mass about an axis that extends perpendicular to the main extension plane are considered especially critical in connection with the clipping behavior. These two (in-plane) interference modes may be resonantly excited in response to spurious excitations having appropriate frequencies, the frequencies for the two mentioned (in-plane) interference modes lying relatively close to the fundamental frequency for the tilting motion. To improve the clipping behavior, the related art therefore suggests to increase the frequencies for the interference modes, for instance by using as torsion spring a spring having a T-shaped cross-section. While it is true that the clipping can be improved in a promising way when using this spring, this approach has the disadvantage that the fault sensitivity of the acceleration sensor with regard to other influences is increased as well. In particular in an acceleration in a direction perpendicular to the axis of rotation and parallel to the main extension plane, a tilting motion that erroneously supplies a signal component can occur.

### SUMMARY OF THE INVENTION

Therefore, it is an object of the present invention to provide an acceleration sensor which reduces the in-plane clipping considerably without markedly increasing the fault sensitivity with regard to other influences in so doing.

This objective may be achieved by an acceleration sensor having a substrate and a seismic mass, the acceleration sensor having a main extension plane and including a spring mechanism, which may be a torsion spring, via which the substrate and the seismic mass are connected in such a way that in an acceleration in a detection direction running perpendicular to the main extension plane, the seismic mass is deflectable, in the sense of a tilting motion, about an axis of rotation running parallel to the main extension plane. According to the present invention, the seismic mass is furthermore connected to the substrate via at least one first spring; the stiffness of the first spring, especially its bending resistance, in a deflection of the seismic mass in the sense of the tilting motion in the detection direction is lower than the stiffness of the first spring, especially its bending resistance, in a deflection in a primary direction running parallel to the main extension plane. In comparison with the related art, this has the advantage that an in-plane movement along the primary direction is suppressed, without the deflection in the detection direction for the seismic mass being restricted in principle. It is therefore possible to restrict an in-plane clipping, i.e., mechanical contact of the seismic mass. In addition, the spring device may be situated within the acceleration sensor in such a way that the mass center of the seismic mass and the axis of rotation which runs parallel to the main extension plane lie at the same level. This advantageously ensures that an acceleration in a direction extending perpendicular to the axis of rotation and parallel to the main extension plane in principle does not lead to a tilting motion of the seismic mass. It is provided that the tilting motion occurs about an axis of rotation that extends parallel to the main extension plane.

According to another specific embodiment, the seismic mass is furthermore connected to the substrate via at least one second spring, whose stiffness, especially its bending resistance, in a deflection of the seismic mass in the sense of the tilting motion is lower than in the detection direction than its stiffness in a deflection in a secondary direction running parallel to the main extension plane. In this context it is provided that the primary direction and the secondary direction run perpendicular to each other. This specific embodiment has the advantage that an in-plane motion is suppressed both along the primary direction and along the secondary direction. It is therefore possible to increase the frequency of potential interference modes. This applies in particular to the interference mode that is associated with the translation motion in a direction perpendicular to the axis of rotation and parallel to the main extension plane, and to the particular interference mode that is associated with the rotary motion about an axis running perpendicular to the main extension plane. At the same time, however, the use of the first and second spring also ensures that the deflection (of the seismic mass in the sense of the tilting motion) in the detection direction is only slightly restricted for the seismic mass.

In one further specific embodiment, at least one part of the first spring is connected to the seismic mass, at a location through which the axis of rotation extends, which runs parallel to the main extension plane or along which this axis of rotation extends. Bending of the substrate due to housing stress then leads to only slight tilting of the seismic mass, and smaller fault signals advantageously occur, which are attributable to the housing stress. The advantageous effect on the in-plane clipping remains unchanged, i.e., the in-plane clipping is improved.

In one additional specific embodiment, the seismic mass has a recess and/or a further recess, in which the first spring and/or the second spring is/are disposed. For example, this makes it possible to place the second spring in such a way that it connects the seismic mass to the substrate as closely as possible to the axis of rotation. This advantageously realizes a lever arm of the shortest possible length, the lever arm relating to the distance between the second spring and the axis of rotation, and the tilting motion corresponding to the associated lever motion. This positioning of the second spring using a shortened lever arm has the advantage that the stiffness of the second spring (in a deflection in the sense of the tilting motion in the detection direction) influences the tilting motion to a lesser extent than a position in which a larger lever arm is assigned to the same second spring (especially if the second spring is placed at the outermost edge of the seismic mass).

If both the first and the second spring are situated within the recesses, an especially compact acceleration sensor is advantageously realized.

One possibility of configuring the first spring and/or the second spring in such a way that its/their stiffness under loading or in a deflection along the detection direction is sufficiently low is to use heavier meandering for the first and/or the second spring. Although this also reduces the stiffness in the primary or secondary direction, it remains far above the stiffness in the detection direction in the present invention.

Another subject matter of the present invention is an acceleration sensor according to the definition of the species in the main claim or according to the main claim. The spring device includes at least one component whose main extension direction runs perpendicular to the axis of rotation running parallel to the main extension plane, the stiffness of the component in a deflection, in the sense of the tilting motion, being lower in the detection direction than the stiffness of the component in a deflection in a primary direction running parallel to the main extension plane, and/or in a deflection in a secondary direction running parallel to the main extension plane. The component enhances or replaces the effect of a first or a second spring. The effect of the first spring causes a reduction in the in-plane clipping along the primary direction, while the effect of the second spring causes a reduction in the in-plane clipping along the secondary direction.

In one further specific embodiment, the component of the spring device replaces the first and/or the second spring, so that the most compact acceleration sensor possible is able to be provided.

In one further specific embodiment, at least one part of the spring device and/or at least one part of the first spring and/or at least one part of the second spring are/is part of an intermediate layer that is able to be structured, the structurable intermediate layer being situated between the substrate and the seismic mass.

In particular, the intermediate layer may be used to place leaf springs between the substrate and seismic mass. The leaf spring is placed in such a way that its broadest side runs parallel to the main extension plane of the acceleration sensor; however, the broadest side of the leaf spring need not be constant along its extension. Instead, it is conceivable that the projection of the leaf spring on a plane running parallel to the main extension plane is triangular or trapezoidal-shaped.

It is provided, in particular, that the leaf springs are developed in such a way that a movement of the seismic mass in the detection direction that does not take place in the sense of the tilting motion is suppressed. This in particular means movements in which the entire seismic mass is shifted parallel to the main extension plane when subjected to an acceleration in the detection direction. This advantageously makes it possible to further reduce the fault sensitivity of the acceleration sensor.

In particular, at least one part of the first spring and/or one part of the second spring and/or one part of the component of the spring device are/is able to be placed below the seismic mass and above the substrate in the detection direction. Space can advantageously be saved as a result of such positioning measures, and the most compact acceleration sensor possible is therefore able to be made available. A first and/or a second recess, in particular, may be dispensed with. This has the advantage that the total mass of the seismic mass need not be reduced in principle, so that a natural frequency for a useful mode (fundamental frequency for the tilting motion) is therefore able to be kept as low as possible, which facilitates the suppression of interference accelerations. As an alternative, it would advantageously also be possible to realize lateral damping fingers and/or fixed mechanical stops and/or elastic mechanical stops above the first spring and/or the second spring.

In alternative developments, the acceleration sensor includes multiple first and/or multiple second springs and/or multiple components of the spring device.

Advantageous embodiments and further refinements of the present invention may be derived from the dependent claims, as well as from the description, with reference to the drawings.

### BRIEF DESCRIPTION OF THE DRAWINGS

FIG. 1 shows a first specific embodiment of an acceleration sensor according to the invention.

FIG. 2 shows a second specific embodiment of an acceleration sensor according to the invention.

FIG. 3 shows a third specific embodiment of an acceleration sensor according to the invention.

FIG. 4 shows a fourth specific embodiment of an acceleration sensor according to the invention.

FIG. 5 shows a side view of the fourth specific embodiment of the acceleration sensor according to the invention.

FIG. 6 shows a fifth specific embodiment of an acceleration sensor according to the invention.

FIG. 7 shows a sixth specific embodiment of an acceleration sensor according to the invention.

FIG. 8 shows a seventh specific embodiment of an acceleration sensor according to the invention.

FIG. 9 shows a side view of the seventh specific embodiment of the acceleration sensor according to the invention.

### DETAILED DESCRIPTION

In the various figures, identical parts have always been provided with the same reference symbols and are therefore usually labeled or mentioned only once.

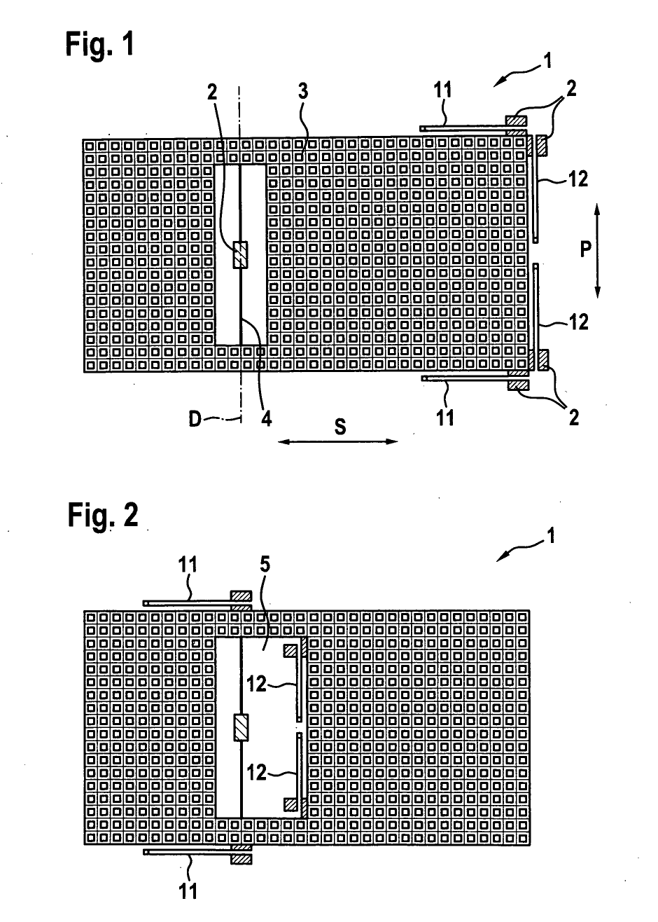

FIG. 1 shows a first specific embodiment of an acceleration sensor 1 according to the present invention. Acceleration sensor 1, which has a main extension plane, includes a substrate 2 and a seismic mass 3. Seismic mass 3 is connected to substrate 2 via a spring device 4, which may be via one or more torsion springs. Spring device 4 is situated in such a way that in an acceleration of the acceleration sensor in a direction perpendicular to the main extension plane, seismic mass 3 is deflectable in the sense of a tilting motion about an axis of rotation that runs parallel to the main extension plane. It is usually also provided that spring device 4 transfers seismic mass 3 back into an idle position when no acceleration is acting on seismic mass 3. In the idle position, seismic mass is situated essentially parallel to the main extension plane of acceleration sensor 1. The reason for a rocker-type motion, i.e., a deflection in the sense of a tilting motion about the axis of rotation, is the fact that the extension of spring device D subdivides seismic mass 3 into two sections having unequal partial masses. In FIG. 1, the smaller of the two unequal partial masses extends to the left of the form of spring device D, and the larger of the two unequal partial masses extends to the right of the form of spring device D. In an acceleration, the unequal partial masses are subjected to different inertial forces, so that a tilting or rocking motion moves the unequal partial masses parallel to a detection direction in directions that are opposite to one another. The detection direction runs perpendicular to the main extension plane of the acceleration sensor. Electrodes are usually situated in substrate 2, with which seismic mass 3 forms a plate-type capacitor. A movement of seismic mass 3 along the detection direction then changes the capacitance of the plate-type capacitor and is therefore able to provide information about the intensity of the acceleration.

According to the present invention, acceleration sensor 1 has a pair of first springs 11, which connect seismic mass 3 to substrate 2 on opposite sides (of seismic mass 3). First springs 11 are characterized by the fact that for one, their stiffness, which may be their bending resistance, is small under loading, especially in a deflection in the sense of a tilting motion, along the detection direction, and for another, their stiffness, which may be their axial rigidity, is great under loading, along a primary direction P extending parallel to the main extension plane. In other words: The first spring is developed in such a way that for one, it does not hamper the tilting motion of the seismic mass in the detection direction as much as a first lateral motion, i.e., the movement of the seismic mass in primary direction P. The pair of first springs is therefore able to suppress a rotary motion of the seismic mass about an axis running perpendicular to the main extension plane and thus advantageously reduce the in-plane clipping.

In addition, acceleration sensor 1 from FIG. 1 includes a pair of second springs 12, which, situated next to each other (parallel to the extension of spring device D), connect seismic mass 3 to substrate 2. Second springs 11 [sic; 12] are characterized by the fact that, on the one hand, their stiffness, which may be their bending resistance, is small under loading along the detection direction, and their stiffness, which may be their axial rigidity, is great under loading in a secondary direction S extending parallel to the main extension plane, on the other. In other words: The second spring is developed in such a way that it does not hamper the rocking motion of the seismic mass in the detection direction as much as a second lateral motion, i.e., the movement of the seismic mass in secondary direction S. The pair of second springs is therefore able to suppress a translation motion of the seismic mass in a direction running perpendicular to the extension of the spring device, and thus advantageously further improve the in-plane clipping.

Another advantage is that in the specific embodiment illustrated, the mass center of the seismic mass and the axis of rotation about which the tilting motion is able to occur lie essentially on one level. This has the advantage that such an acceleration sensor is usually not sensitive to interference caused by accelerations that take place in a direction perpendicular to the extension of spring device D and parallel to the main extension plane.

It is provided, in particular, that the first spring is more heavily meandered in the primary direction and/or the second spring in the secondary direction, than shown in FIG. 1, which reduces the rigidity of the first spring and/or the second spring under loading along the detection direction. This applies also to all other first and/or second springs shown in the following specific embodiments.

The specific embodiments shown in the following figures for acceleration sensors according to the present invention essentially have the same features as the acceleration sensor according to the first specific embodiment or according to one of the aforementioned specific embodiments. For this reason the description of the parts already described in FIG. 1 or described in one of the aforementioned specific embodiments is avoided or simplified. Essentially, in particular the differences with regard to the previous specific embodiments are highlighted.

FIG. 2 shows a second specific embodiment of an acceleration sensor according to the invention; this particular acceleration sensor differs from the specific embodiment of FIG. 1 by the placement of the first pair of springs 11 or the second pair of springs 12 in relation to seismic mass 3. It is provided that (at least) one first spring 11 is disposed in the region of the seismic mass, across which spring direction D extends as well. In this way the pair of first springs 11 is situated in the immediate vicinity of the axis of rotation. Experience has shown that substrate bending due to housing stress is therefore transmitted to a lesser extent to seismic mass 3, and smaller fault signals caused by the housing stress are advantageously produced. The advantageous effect on the in-plane clipping is retained.

In addition, the seismic mass has a recess 5 along the detection direction. In the specific embodiment at hand, the pair of second springs 12 is situated in this recess. This shifts the pair of second springs 12 closer to the axis of rotation, which shortens a lever arm for a tilting motion of the seismic mass about the axis of rotation (in comparison with the placement in FIG. 1). As a consequence, it is advantageously not necessary to reduce the stiffness of second spring 12 (or the pair of second springs) in loading in the detection direction to the extent that it would be required if second spring 12 were connected to the seismic mass at the point farthest away from the axis of rotation. The advantageous effect on the in-plane clipping is retained.

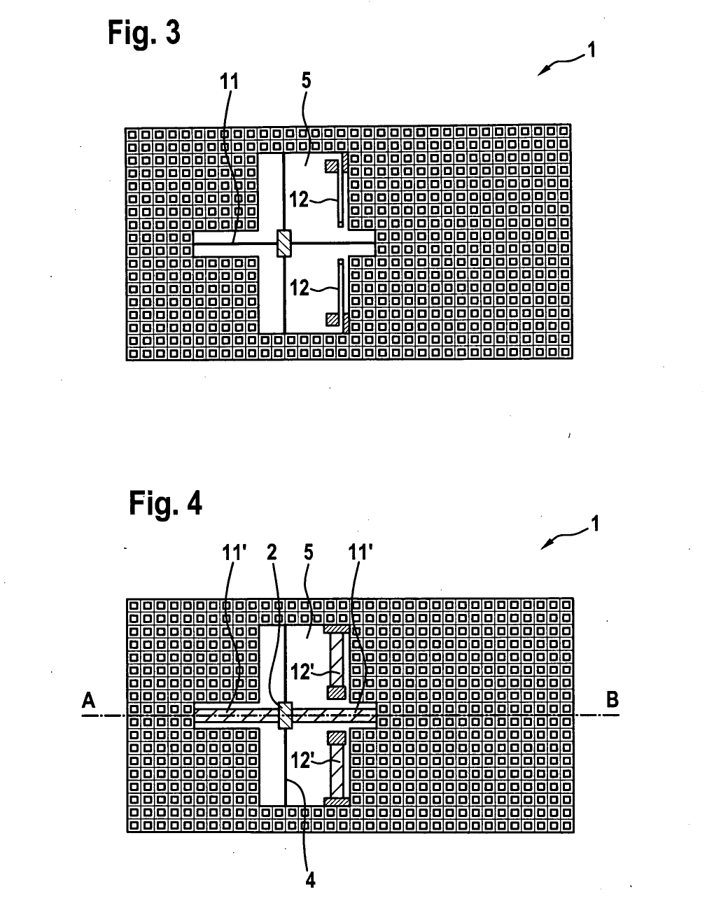

FIG. 3 shows a third embodiment of an acceleration sensor according to the present invention. In comparison with the embodiment of FIG. 2, in this specific embodiment the pair of first springs 11 is [replaced?] by a single bar spring 11, the two single bar springs being situated in another recess 8 which extends perpendicular to the extension of spring device D. However, they are no longer situated opposite each other but lie together in one line parallel to secondary direction S. This specific embodiment has the advantage of being particularly compact, especially when compared to the specific embodiments of FIGS. 1 and 2. The advantageous effect on the in-plane clipping is retained.

FIG. 4 shows a fourth embodiment of an acceleration sensor according to the present invention. The positions for the pair of first springs 11′ and the pair of second springs 12 that are known from the specific embodiment of FIG. 3 remain. The pair of first springs 11′ and the pair of second springs 12 differ from those in FIG. 3 in that they are part of an intermediate layer which is situated between substrate 2 and seismic mass 3. In this specific embodiment, first and/or second springs 11′ may be leaf springs. In comparison with the seismic mass, the intermediate layer is thinner by approximately a factor of 2-15. This advantageously makes it possible to place leaf springs between the substrate and seismic mass, whose stiffness under loading in the detection direction is able to be controlled via the thickness of the intermediate layer.

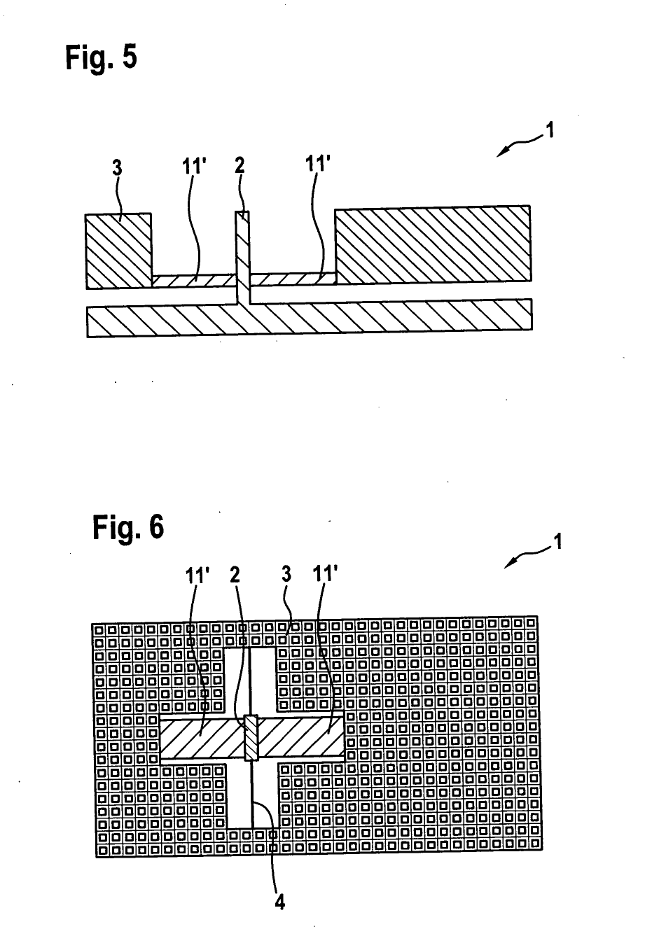

FIG. 5 shows a side view of an acceleration sensor according to the fourth specific embodiment, along sectional plane A-B. This representation makes it clear that the center of mass of seismic mass 3 and the axis of rotation (for the tilting motion) do not lie at the same level. In this specific embodiment, acceleration sensor 1 therefore has a certain susceptibility to accelerations that run perpendicular to the axis of rotation. However, the fault sensitivity is advantageously low in comparison with acceleration sensors known from the related art, because in the specific embodiment at hand, first spring 11′ is loaded in a different manner than the spring having the T-shaped cross-section, especially because more of a translation than a torsion takes place.

FIG. 6 shows a fifth embodiment of an acceleration sensor according to the present invention. The fifth specific embodiment differs from the embodiment of FIGS. 4 and 5 in that the cross-section of the spring running parallel to the main extension plane is greater than the cross-section of the spring of FIG. 4; in particular, the first spring extends across a larger distance along the primary direction, i.e., the width of the leaf springs is enlarged. As a result, the stiffness of the pair of first springs under loading is increased both along the primary and the secondary direction, to such an extent that it is advantageously possible to dispense with the second pair, while the improvement in the in-plane clipping is able to be ensured nonetheless.

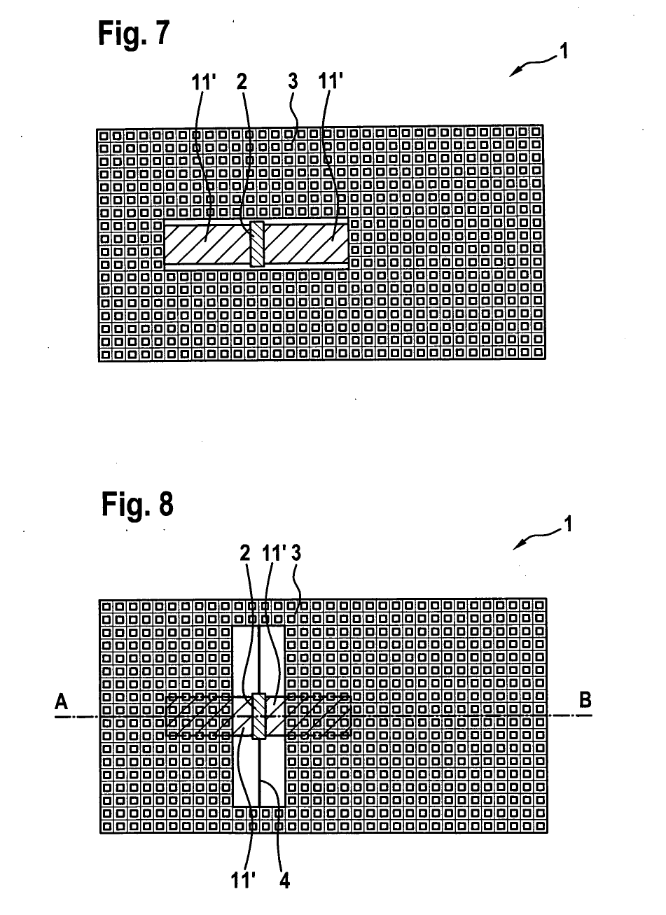

FIG. 7 shows a sixth specific embodiment of an acceleration sensor according to the invention. In comparison with the specific embodiment of FIG. 6, spring device 4 and recess 5 are dispensed with in this acceleration sensor. This has the advantage of providing an especially compact acceleration sensor.

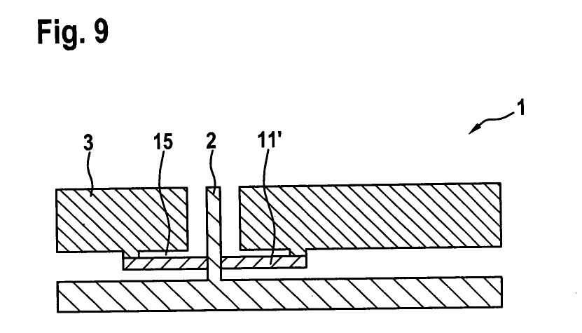

FIG. 8 shows a seventh embodiment of an acceleration sensor according to the present invention. In comparison with the specific embodiment of FIG. 6, additional recess 8 is omitted in acceleration sensor 1, i.e., seismic mass 3 extends partially along the detection direction above the pair of first springs 11′. This has the advantage that the total mass of the seismic mass need not be reduced in principle, so that a natural frequency for a useful mode (fundamental frequency for the tilting motion) is therefore able to be kept as low as possible, which facilitates the suppression of interference accelerations. As an alternative, it would also be possible to advantageously realize lateral damping fingers and/or fixed mechanical stops and/or elastic mechanical stops above the pair of first springs.

FIG. 9 shows a side view of acceleration sensor 1 according to the seventh specific embodiment, along sectional plane A-B. Two bending springs can be seen, which have been created by the structuring of the intermediate layer and which are directly connected to seismic mass 3 at their outer ends in each case. Technically, the connection is realized via a local opening of an oxide layer between seismic mass 3 and the intermediate layer, the seismic mass being deposited directly onto the intermediate layer. In a subsequent production step, which may be during the gas-phase etching, the oxide is removed from the regions in which the seismic mass and the intermediate layer are not interconnected, which produces a gap 15 between the intermediate layer and seismic mass 3.

What is claimed is:

1. An acceleration sensor, comprising:
an acceleration sensor arrangement, including:
a substrate;
a seismic mass, wherein the acceleration sensor arrangement includes a main extension plane; and
a spring device, via which the substrate and the seismic mass are connected, such that in an acceleration in a detection direction that runs perpendicular to the main extension plane, the seismic mass is deflectable in the sense of a tilting motion about an axis of rotation that runs parallel to the main extension plane, wherein the seismic mass is further connected to the substrate via at least one first spring, the stiffness of the first spring in a deflection of the seismic mass in the sense of the tilting motion in the detection direction being lower than the stiffness of the first spring in a deflection in a primary direction that runs parallel to the main extension plane.

2. The acceleration sensor of claim 1, wherein the spring device includes at least one component whose main extension direction runs perpendicular to the axis of rotation extending parallel to the main extension plane, the stiffness of the component in a deflection in the sense of the tilting motion in the detection direction being lower than the stiffness of the component in a deflection in a primary direction that runs parallel to the main extension plane and/or in a deflection in a secondary direction that runs parallel to the main extension plane.

3. The acceleration sensor of claim 1, wherein the seismic mass is further connected to the substrate via at least one second spring, whose stiffness in a deflection of the seismic mass in the detection direction is lower than its stiffness in a deflection in a secondary direction that runs parallel to the main extension plane, the primary direction and the secondary direction extending perpendicular to one another.

4. The acceleration sensor of claim 1, wherein at least one part of the first spring is connected to the seismic mass at a location through which the axis of rotation extends, which runs parallel to the main extension plane.

5. The acceleration sensor of claim 1, wherein the seismic mass has a recess and/or a further recess, in which the first spring and/or the second spring is disposed.

6. The acceleration sensor of claim 1, wherein at least one part of the spring device and/or at least one part of the first spring and/or at least one part of the second spring is part of one or multiple intermediate layers able to be structured, the one or the multiple structurable intermediate layers being situated between the substrate and the seismic mass.

7. The acceleration sensor of claim 1, wherein the seismic mass extends at least partially above the first spring and/or the second spring in the detection direction.
